(19) United States
(12) Patent Application Publication
(10) Pub. No.: US 2026/0110198 A1
(43) Pub. Date: Apr. 23, 2026

(54) FRUNK LATCH APPARATUS

(71) Applicant: PHA CO., LTD., Daegu (KR)

(72) Inventors: SUNG HAN KIM, Daegu (KR); NAM KYU JEON, Daegu (KR); TAE SUNG KIM, Daegu (KR); HYEON TAE PARK, Daegu (KR)

(21) Appl. No.: 19/340,607

(22) Filed: Sep. 25, 2025

(30) Foreign Application Priority Data
Oct. 21, 2024 (KR) 10-2024-0144413

(51) Int. Cl. E05B 81/38; E05B 81/06; E05B 81/20; E05B 81/30; E05B 81/36; E05B 83/24

(52) U.S. Cl. CPC E05B 81/38; E05B 81/06; E05B 81/20; E05B 81/30; E05B 81/36; E05B 83/24

(57) ABSTRACT

The present invention relates to a frunk latch apparatus, and there is provided a frunk latch apparatus including a base, a driving unit provided on the base, a driven gear unit connected to the driving unit, a latch unit provided on the base to control opening or closing of a door, a sector gear unit that is rotated by the driven gear unit and switches the latch unit to a completely locked state, and a de-clutch unit configured to block power transmission from the driven gear unit to the sector gear unit to stop switching the latch unit to the completely locked state.

### CROSS-REFERENCE TO RELATED APPLICATION

This application claims priority to and the benefit of Korean Patent Application No. 10-2024-0144413, filed on Oct. 21, 2024, the disclosure of which is incorporated herein by reference in its entirety.

### BACKGROUND

### 1. Field of the Invention

The present invention relates to a frunk latch apparatus, and more specifically, to a frunk latch apparatus in which a power release function and a power cinching function are integrated.

### 2. Discussion of Related Art

Generally, a latch apparatus is installed in a vehicle. The latch apparatus performs the locking or unlocking of a door or trunk by mechanical restraint in a closing or opening process of the door or trunk. That is, when a user pulls the door or a handle of the trunk, since the handle and the latch apparatus are mechanically connected, the latch apparatus can be unlocked.

However, in conventional electric vehicles, a trunk is disposed even in the front of a vehicle body to maximize space utilization, but there is a problem of degraded product reliability because the locking or unlocking of the trunk is not performed smoothly.

In addition, in conventional electric vehicles, a latch part is installed to lock o unlock the trunk, and an actuator is installed to operate the latch part. Since an actuator is formed such that a gear or a lever part is rotatably installed, the latch part implements a cinching mode and a release mode. In addition, when a pair of latch parts are installed on a trunk, the actuator is connected to each latch part to implement the cinching mode and the release mode in the latch part. Accordingly, the number of parts and manufacturing cost of an electric vehicle can also be increased.

Accordingly, there is a need to solve the above problems.

The background technology of the present invention is disclosed in Korean Laid-Open Patent No. 2005-0050652 (published on May 31, 2005, title: Driving device and door closer).

### SUMMARY OF THE INVENTION

The present invention is directed to providing a frunk latch apparatus capable of performing a power release function and a cinching function using a single driving unit.

According to the present invention, there is provided a frunk latch apparatus including a base, a driving unit provided on the base, a driven gear unit connected to the driving unit, a latch unit provided on the base to control opening or closing of a door, a sector gear unit that is rotated by the driven gear unit and switches the latch unit to a completely locked state, and a de-clutch unit configured to block power transmission from the driven gear unit to the sector gear unit to stop switching the latch unit to the completely locked state.

The latch unit may include a claw provided to be rotatable on the base, and a pawl that is engaged with the claw and restrains a strike inserted into the claw.

The driven gear unit may include a sun gear engaged and rotated with an output power shaft of the driving unit, a driven gear unit that is engaged and rotated with the sun gear, a ring gear engaged with the driven gear unit, and a spur gear coupled to the driven gear unit and engaged with the sector gear unit.

The frunk latch apparatus may further include a cinching operation unit configured to switch the latch unit to the completely locked state in conjunction with rotation of the sector gear unit in the other direction, wherein the cinching operation unit may include a cinching operation member configured to rotate together with the sector gear unit, and a contact pin formed on the claw to be in contact with the cinching operation member and move the claw to a completely locked position.

The de-clutch unit may include a de-clutch lever that is provided to be rotatable on the base and applies a de-clutch operation, and a power blocking unit configured to block power transmission from the driving unit to the driven gear unit by rotation of the de-clutch lever.

The ring gear may be provided to be rotatable on the base, and the power blocking unit may include a restraining shaft that is slidably provided on the base and restrains rotation of the ring gear, an elastic member configured to provide an elastic force so that the restraining shaft is coupled to the ring gear, and an operating member configured to release restraint of the ring gear by moving the restraining shaft when the de-clutch lever operates.

A guide groove that guides a sliding movement of the restraining shaft may be formed in the base.

The operating member may include a first gear portion formed on the de-clutch lever, and a second gear portion formed in a longitudinal direction of the restraining shaft to be engaged with the first gear portion.

The frunk latch apparatus may further include an opening operation unit configured to open the latch unit in conjunction with rotation of the sector gear unit in one direction, wherein the opening operation unit may include a release operation member rotated together with the sector gear unit, and a power drive lever unit that is in contact and rotated with the release operation member and rotates the pawl.

A rolling roller may be provided on the release operation member, and a guide rib in contact with the rolling roller may be formed on the power drive lever unit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view for describing a frunk latch apparatus according to one embodiment of the present invention;

FIG. 2 is an exploded perspective view for describing the frunk latch apparatus according to one embodiment of the present invention;

FIG. 3 is an exploded perspective view for describing the frunk latch apparatus according to one embodiment of the present invention in a different direction;

FIG. 4 is an exploded perspective view of main parts of the frunk latch apparatus according to one embodiment of the present invention;

FIG. 5 is an exploded perspective view showing the main parts of the frunk latch apparatus according to one embodiment of the present invention in a different direction;

FIG. 6 is a front view showing an internal configuration of the frunk latch apparatus according to one embodiment of the present invention;

FIG. 7 is a rear view showing the internal configuration of the frunk latch apparatus according to one embodiment of the present invention;

FIG. 8 is a front view for describing a power release operation of the frunk latch apparatus according to one embodiment of the present invention;

FIG. 9 is a rear view for describing the power release operation of the frunk latch apparatus according to one embodiment of the present invention;

FIG. 10 is a front view for describing a cinching operation of the frunk latch apparatus according to one embodiment of the present invention;

FIG. 11 is a rear view for describing the cinching operation of the frunk latch apparatus according to one embodiment of the present invention;

FIG. 12 is a front view for describing a de-clutch operation of the frunk latch apparatus according to one embodiment of the present invention;

FIG. 13 is a view showing position detection by the power release operation of the frunk latch apparatus according to one embodiment of the present invention; and

FIG. 14 is a view showing position detection by the cinching operation of the frunk latch apparatus according to one embodiment of the present invention.

### DETAILED DESCRIPTION OF EXEMPLARY EMBODIMENTS

Hereinafter, exemplary embodiments of a frunk latch apparatus according to one embodiment of the present invention will be described with reference to the accompanying drawings. In this description, thicknesses of lines, sizes of components, and the like shown in the drawings may be exaggerated for clarity and convenience of the description.

In addition, terms to be described below are terms defined in consideration of functions in the present invention, which may be changed according to a user or operator's intention or custom. Accordingly, the definition of these terms should be made based on the description throughout the present specification.

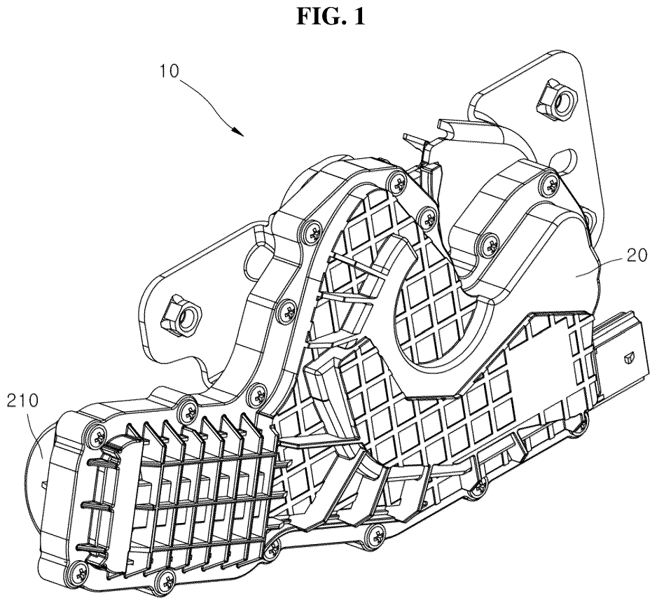

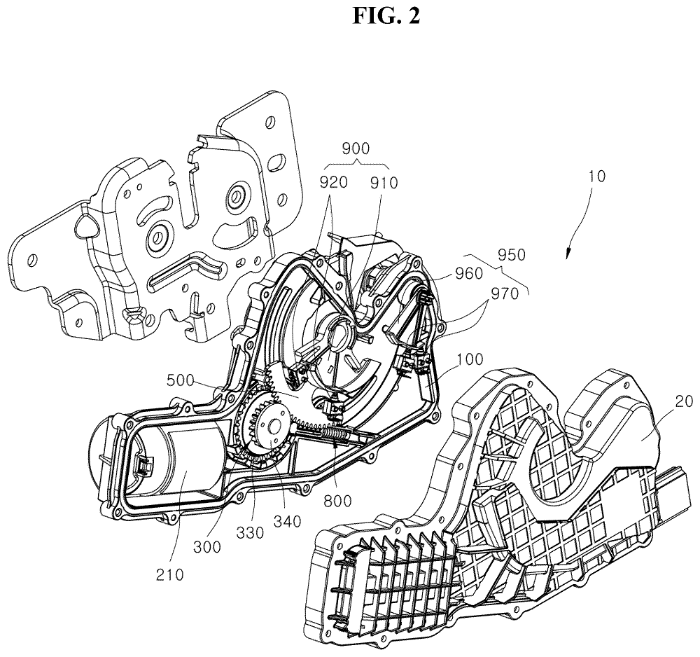

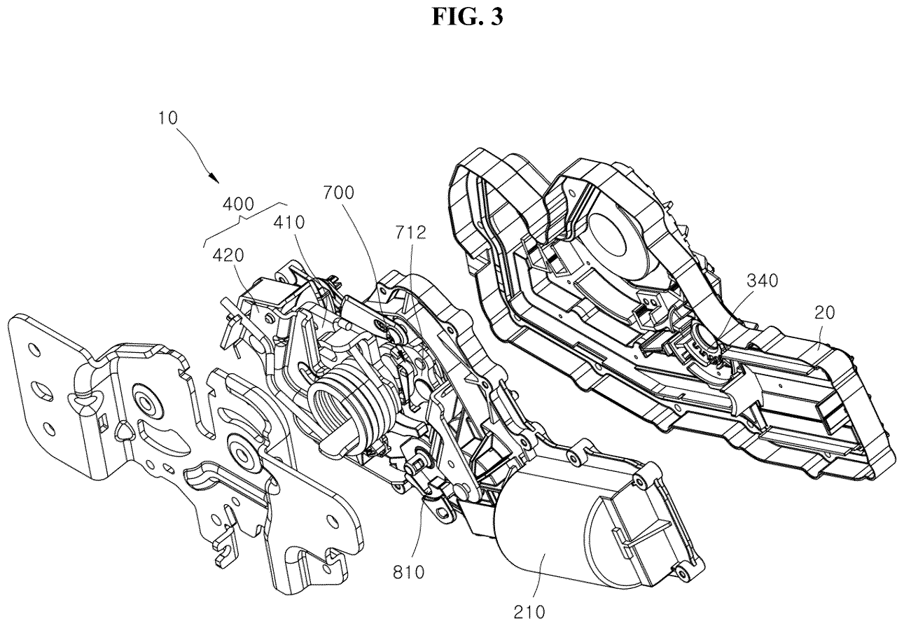

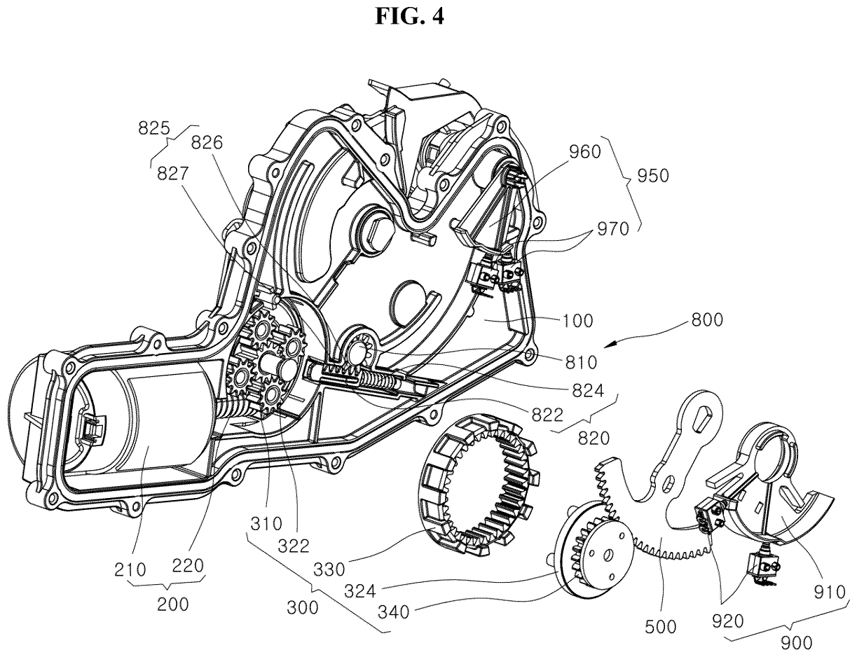

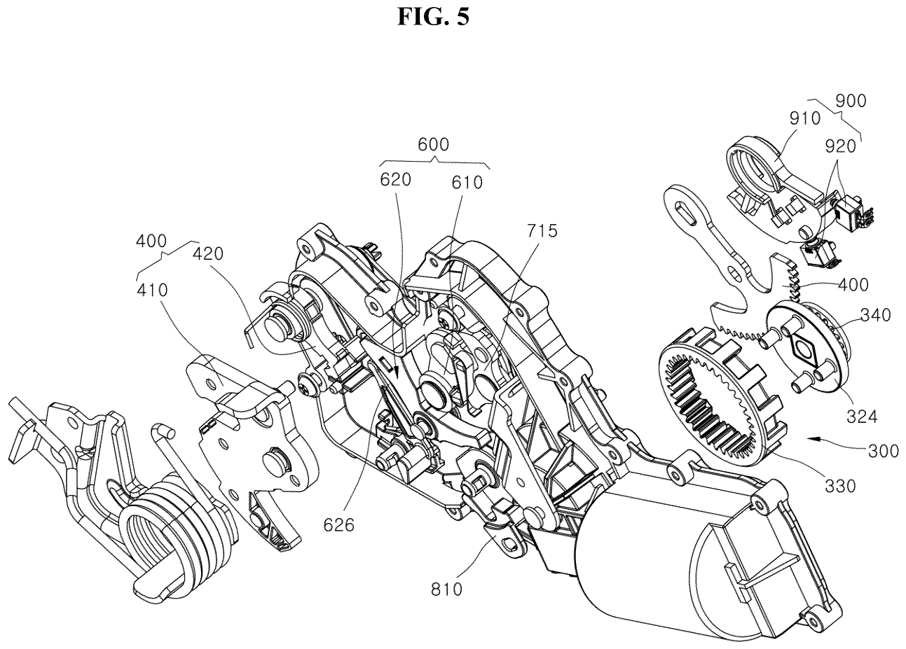

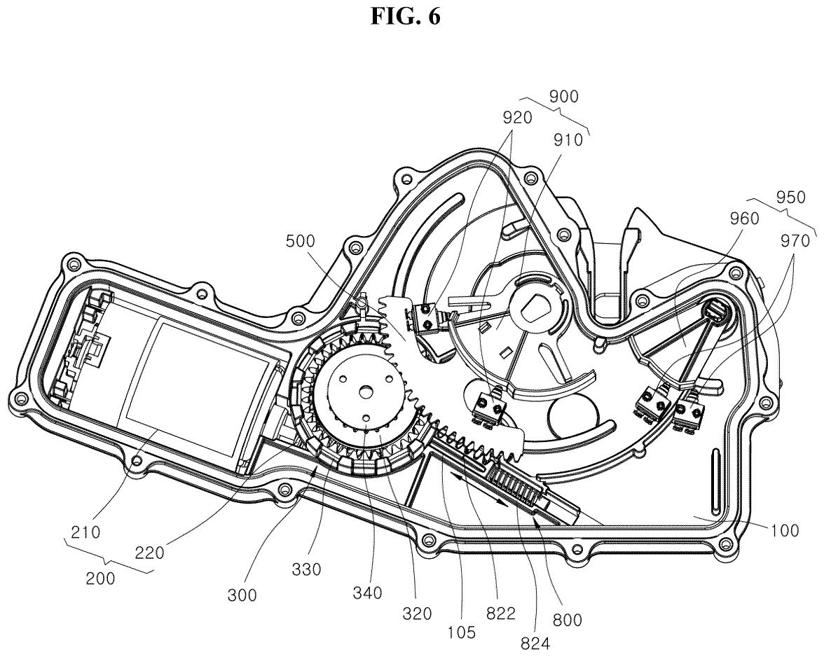

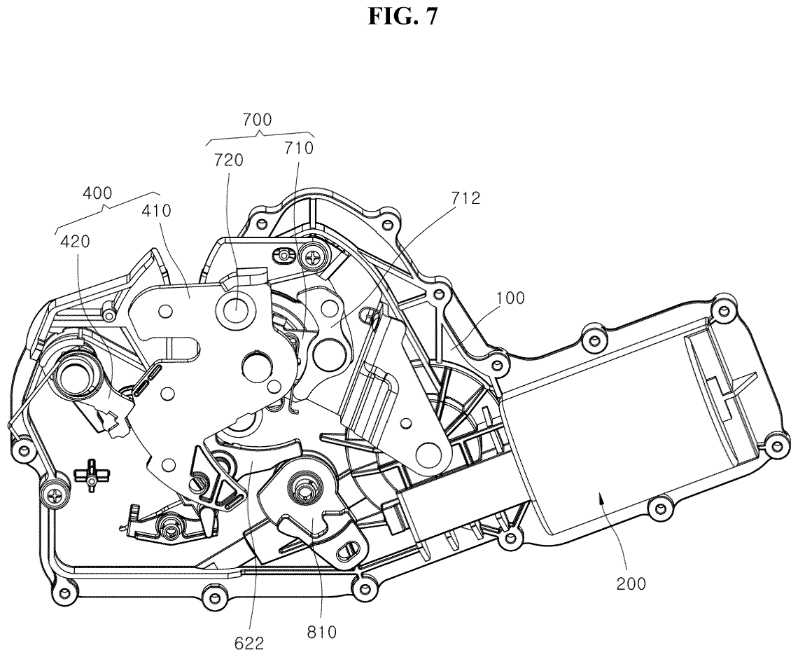

FIG. 1 is a perspective view for describing a frunk latch apparatus according to one embodiment of the present invention, FIG. 2 is an exploded perspective view for describing the frunk latch apparatus according to one embodiment of the present invention, FIG. 3 is an exploded perspective view for describing the frunk latch apparatus according to one embodiment of the present invention in a different direction, FIG. 4 is an exploded perspective view of main parts of the frunk latch apparatus according to one embodiment of the present invention, FIG. 5 is an exploded perspective view showing the main parts of the frunk latch apparatus according to one embodiment of the present invention in a different direction, FIG. 6 is a front view showing an internal configuration of the frunk latch apparatus according to one embodiment of the present invention, and FIG. 7 is a rear view showing the internal configuration of the frunk latch apparatus according to one embodiment of the present invention.

Referring to FIGS. 1 to 7, a frunk latch apparatus 10 according to one embodiment of the present invention may include a base 100, a driving unit 200, a planetary gear unit 320, a latch unit 400, and a sector gear unit 500.

The base 100 is formed in a plate shape, and components are disposed in a link-connected manner. The base 100 may be disposed in a housing 20.

The driving unit 200 may be provided on the base 100 and serve as a component that provides a driving force for rotating the sector gear unit 500.

More specifically, the driving unit 200 may include a motor unit 210 that is provided on the base 100 and generates power, and a worm gear 220 that is provided on an output power shaft of the motor unit 210.

The latch unit 400 may be provided on the base 100 to control the opening or closing of a door and may include a claw 410 that is provided to rotate on the base 100 and a pawl 420 that is engaged with the claw 410 and restrains a strike inserted into the claw 410.

When the engagement of the claw 410 and the pawl 420 is released, the restraint of the strike may be released by the rotation of the claw 410.

A driven gear unit 300 may include a planetary gear 322 and may serve as a component that transmits higher power when transmitting the power of the driving unit 200 to the sector gear unit 500. In addition, the design for downsizing as well as high power transmission are possible by the driven gear unit 300, enabling miniaturization of the frunk latch apparatus 10, and high-density gear design is possible while providing a multi-stage gear ratio.

The driven gear unit 300 may include a sun gear 310 that is engaged and rotated with the output power shaft of the driving unit 200, a planetary gear unit 320 that is engaged and rotated with the sun gear 310, a ring gear 330 that is engaged with the planetary gear unit 320, and a spur gear 340 that is coupled to the planetary gear unit 320 and engaged with the sector gear unit 500.

The planetary gear unit 320 may include a plurality of planetary gears 322 formed on a circumferential surface of the sun gear 310 and a carrier 334 that is coupled to the planetary gears 322 and rotated together with the planetary gears 322.

Since a polygonal protrusion coupled to the carrier 334 may be formed on the spur gear 340, the carrier 334 and the spur gear 340 may rotate together.

Accordingly, the driving force of the driving unit 200 may provide high power by the driven gear unit 300 including the planetary gear 322.

The ring gear 330 is provided to rotate on the base 100. This is a component for performing a de-clutch function, which will be described in detail below.

The sector gear unit 500 may serve as a component that is rotated by the driven gear unit 300 and opens the latch unit 400 or switches the latch unit 400 to a completely locked state depending on a direction of rotation.

The sector gear unit 500 may be provided to rotate on the base 100, rotated by the driven gear unit 300, and perform the opening operation or the cinching operation of the latch unit 400 depending on the direction of rotation of the sector gear unit 500.

That is, the sector gear unit 500 may rotate in one direction or a direction opposite thereto depending on the rotation of the driving unit 200.

The sector gear unit 500 is a T-shaped gear, and gear teeth formed on an outer surface thereof may be engaged with the spur gear 340 and rotate about a center axis.

The sector gear unit 500 may include an opening operation unit 600 for opening the latch unit 400 in conjunction with the rotation in one direction. The opening operation unit 600 may serve as a component that opens the latch unit 400 by the rotation of the sector gear unit 500 in one direction.

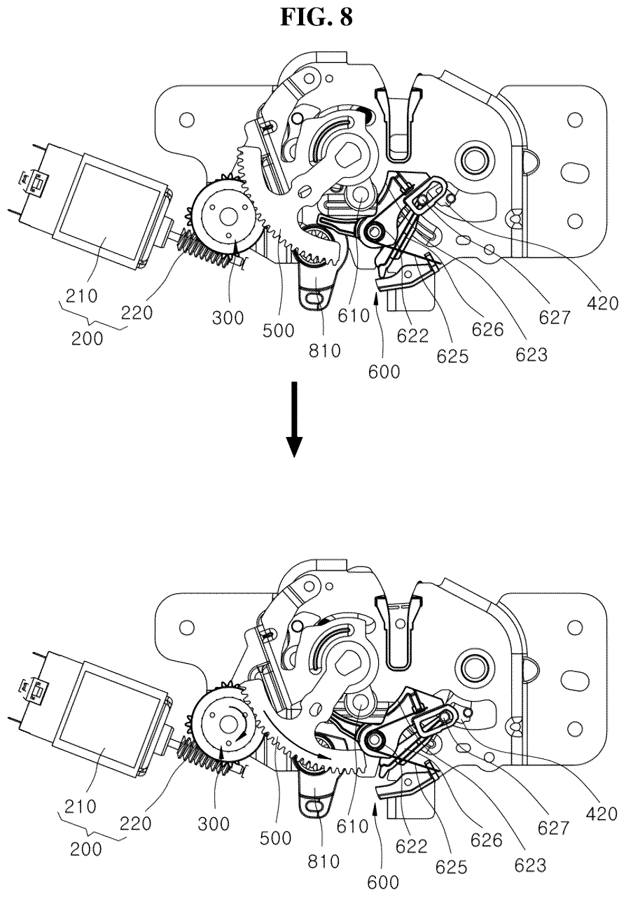

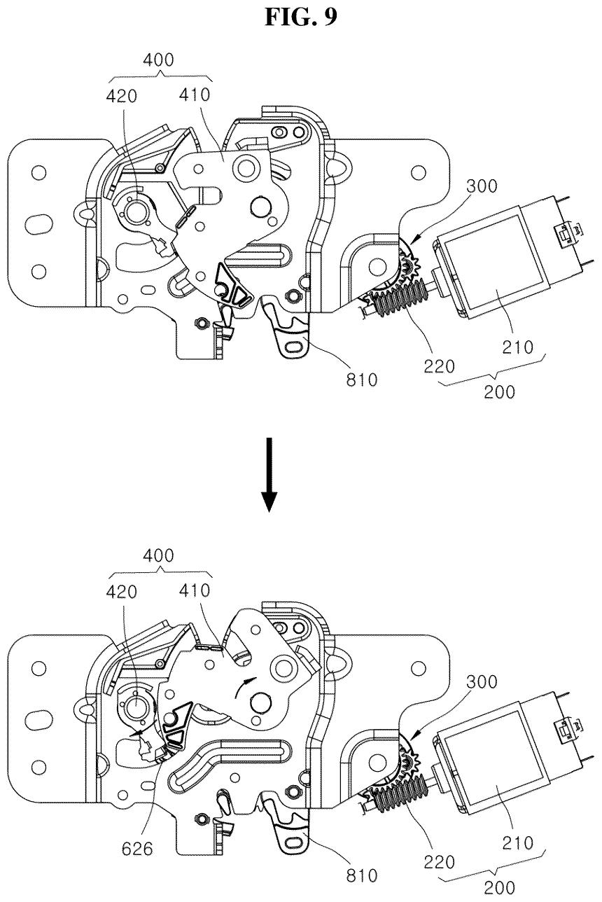

FIG. 8 is a front view for describing a power release operation of the frunk latch apparatus 10 according to one embodiment of the present invention, and FIG. 9 is a rear view for describing the power release operation of the frunk latch apparatus 10 according to one embodiment of the present invention.

Referring to FIGS. 1 to 9, the opening operation unit 600 may open the latch unit 400 by the rotation of the sector gear unit 500 in one direction.

Here, the rotation of the sector gear unit 500 in one direction is a counterclockwise rotation about the center axis of the sector gear unit 500 based on FIG. 7.

For example, the opening operation unit 600 may include a release operation member 610 rotated together with the sector gear unit 500 and a power drive lever unit 620 that is in contact and rotated with the release operation member 610 to rotate the pawl 420.

The release operation member 610 has the sector gear unit 500 and a concentric shaft and is formed to extend in a radial direction to correspond to the rotation of the sector gear unit 500 in one direction.

The power drive lever unit 620 may include a rotational lever 622 that is rotatably coupled to the base 100 and rotated when into contact with the release lever, a restoration member 625 that elastically supports the rotational lever 622 and returns the rotational lever 622 to its initial position when disconnected from the release lever, and a pressing bar 626 that is moved by the rotation of the rotational lever 622 to press the pawl 420.

A long hole 624 is formed in an end portion of the rotational lever 622, and a connecting protrusion 627 connected to the long hole 624 is formed on an end portion of the pressing bar 626. This is a structure that moves the pressing bar 626 in primary and secondary stages, and may primarily move the pressing bar 626 when the rotational lever 622 rotates primarily and secondarily move the pressing bar 626 when the rotational lever 622 rotates secondarily from a first movement position, and thus the claw 410 and the pawl 420 may be separated during the primary movement to switch a completely locked state to a primarily locked state and switch the primarily locked state to an open state during the secondary movement.

A rolling roller 612 may be provided on an end portion of the release operation member 610, and a guide rib 623 in contact with the rolling roller 612 may be formed on the rotational lever 622. Accordingly, it is possible to minimize a frictional force by the rolling roller 612, thereby preventing operating noise.

More specifically, the driven gear unit 300 is rotated by the driving force of the motor unit 210, and the sector gear unit 500 engaged with the spur gear 340 is rotated counterclockwise by the rotation of the driven gear unit 300. When the release operation member 610 comes into contact with the rotational lever 622 by the rotation of the sector gear unit 500 and rotates the rotational lever 622, the pressing bar 626 connected to the long hole 624 may move primarily to press the pawl 420, thereby releasing the engagement to switch the claw 410 and the pawl 420 from the completely locked state to the primarily locked state, and the rotational lever 622 is re-rotated so that the pressing bar 626 secondarily moves from the primary movement position to press the pawl 420, thereby switching the claw 410 and the pawl 420 from the primarily locked state to the open state.

The present embodiment may include a cinching operation unit 700 for switching the latch unit 400 to the completely locked state in conjunction with the rotation of the sector gear unit 500 in the other direction.

The cinching operation unit 700 may serve as a component that switches the latch unit 400 to the completely locked state by the rotation of the sector gear unit 500 in the other direction.

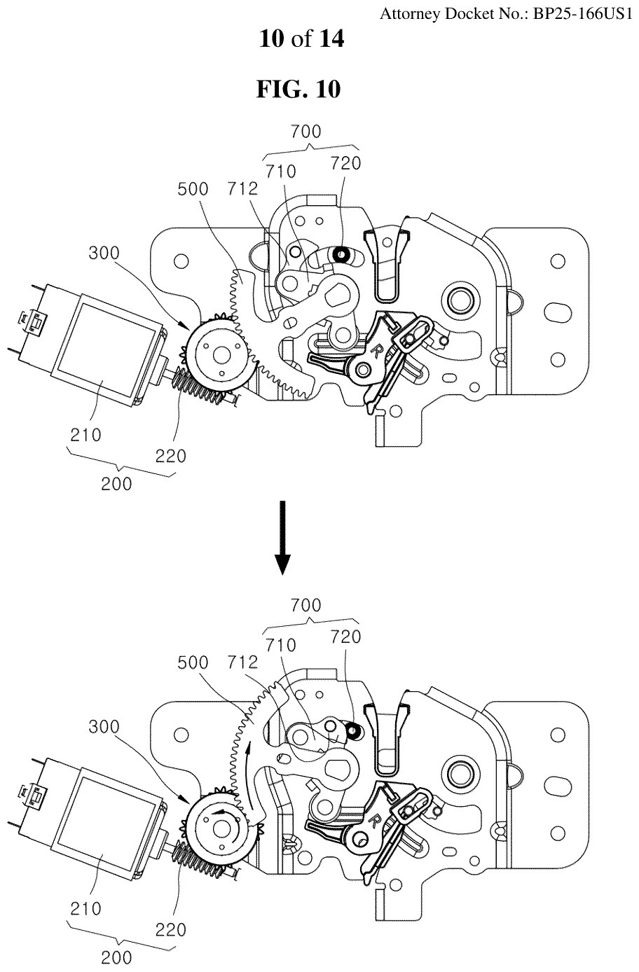

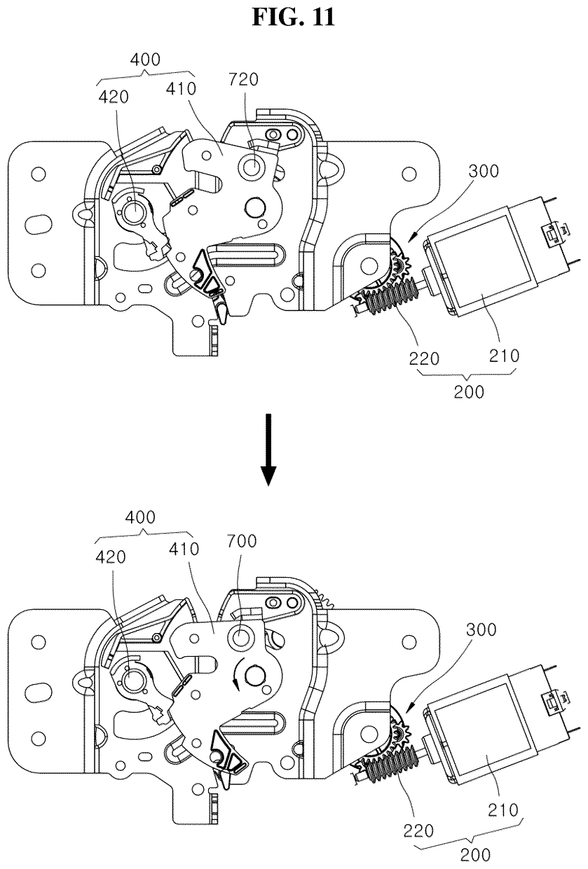

FIG. 10 is a front view for describing a cinching operation of the frunk latch apparatus 10 according to one embodiment of the present invention, and FIG. 11 is a rear view for describing the cinching operation of the frunk latch apparatus 10 according to one embodiment of the present invention.

Referring to FIGS. 1 to 7, 10, and 11, the cinching operation unit 700 may rotate the claw 410 by the rotation of the sector gear unit 500 in the other direction to switch the latch unit 400 to the completely locked state.

Here, the rotation of the sector gear unit 500 in the other direction is a clockwise rotation about the center axis of the sector gear unit 500 based on FIG. 9.

For example, the cinching operation unit 700 may include a cinching operation member 710 that rotates together with the sector gear unit 500 and a contact pin 720 in contact with the cinching operation member 710 to switch the claw 410 to the completely locked state.

The cinching operation member 710 has the sector gear unit 500 and a concentric shaft and is formed to extend in a radial direction to correspond to the rotation of the sector gear unit 500 in the other direction.

In this case, the release operation member 610 and the cinching operation member 710 may be formed as a single component. That is, a portion formed in a “V” shape and extending counterclockwise about the sector gear unit 500 may be formed as the release operation member 610, and a portion extending clockwise may be formed as the cinching operation member 710.

A contact lever 712 is hinge-connected to the claw 410 at an end portion of the cinching operation member 710, and the contact lever 712 is elastically supported by the cinching operation member 710 and provided to face the contact pin 720 of the claw 410.

Accordingly, the cinching operation member 710 may be rotated together by the clockwise rotation of the sector gear unit 500, and the contact lever 712 formed on the end portion of the cinching operation member 710 may press the contact pin 720 of the claw 410 to rotate the claw 410, thereby switching the claw 410 from the primarily locked state to the completely locked state.

The present embodiment may include a de-clutch unit 800 for stopping the cinching operation during the cinching operation of the cinching operation unit 700.

The de-clutch unit 800 may serve as a component capable of responding to an unexpected situation, such as jamming or the like, during the cinching operation of the door.

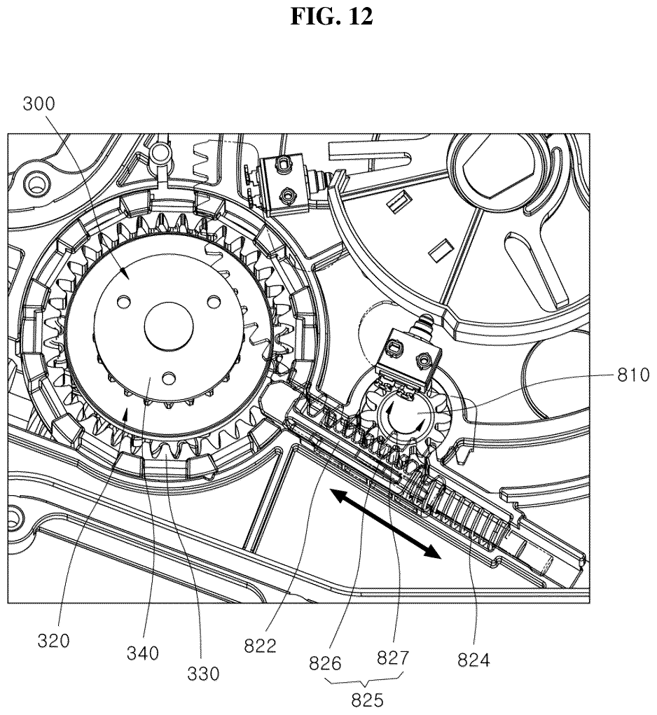

FIG. 12 is a front view for describing a de-clutch operation of the frunk latch apparatus according to one embodiment of the present invention.

Referring to FIGS. 1 to 7 and 12, the de-clutch unit 800 according to the present embodiment may stop switching the latch unit 400 to the completely locked state by blocking the power transmission of the driven gear unit 300 and the sector gear unit 500.

For example, the de-clutch unit 800 may include a de-clutch lever 810 that is provided to rotate on the base 100 and applies the de-clutch operation, and a power blocking unit 820 for blocking the power transmission of the driving unit 200 and the driven gear unit 300 by the rotation of the de-clutch lever 810.

The de-clutch lever 810 may be connected to a handle or operating switch provided on a frunk. Accordingly, in case of an emergency, the de-clutch function may be performed by operating the handle or operating switch.

The de-clutch lever 810 also performs a release function. That is, the de-clutch lever 810 may come into contact with the rotational lever 622 when rotating, thereby rotating the rotational lever 622, and since the pressing bar 626 moves the pawl 420 by the rotation of the rotational lever 622, the de-clutch lever 810 may perform an opening operation by releasing the engagement between the claw 410 and the pawl 420.

The power blocking unit 820 may include a restraining shaft 822 that is slidably provided on the base 100 and restrains the rotation of the ring gear 330, an elastic member 824 that applies an elastic force so that the restraining shaft 822 is coupled with the ring gear 330, and an operating unit for moving the restraining shaft 822 during the operation of the de-clutch lever 810 to release the restraining of the ring gear 330.

A guide groove 105 that guides the sliding movement of the restraining shaft 822 may be formed in the base 100. The restraining shaft 822 may be slid along a straight line by the guide groove 105 and accurately coupled to or separated from the ring gear 330.

An operating member 825 may include a first gear portion 826 formed on the de-clutch lever 810 and a second gear portion 827 formed in a longitudinal direction of the restraining shaft 822 to be engaged with the first gear portion 826.

In the present embodiment, the operating member 825 converts a rotational motion into a linear motion of the de-clutch lever 810 by a gear structure, but is not limited thereto, and various modified designs are possible, such as a link structure that converts the rotational motion of the de-clutch lever 810 into a linear motion of the restraining shaft 822.

The ring gear 330 is provided to rotate on the base 100. Since the ring gear 330 is not rotated in a state in which the restraining shaft 822 is coupled to the ring gear 330, the power of the planetary gear unit 320 may be transmitted to the sector gear unit 500 through the spur gear 340, and since the ring gear 330 rotates together with the planetary gear unit 320 in a state in which the restraining shaft 822 is separated from the ring gear 330, power transmission can be blocked.

That is, when the de-clutch lever 810 is rotated by an external signal during the cinching operation by the clockwise rotation of the sector gear unit 500, the restraining shaft 822 may be moved rearward along the guide groove 105 by the operating member 825 and separated from the ring gear 330, and the ring gear 330 is in a rotatable state, and thus the planetary gear 322 may rotate idly to block the power transmission, thereby preventing the switching of the claw 410 from the primarily locked state to the completely locked state.

In addition, since the de-clutch lever 810 rotates the rotational lever 622 to move the pawl 420, the engagement between the claw 410 and the pawl 420 is released, and the latch unit 400 enters an open state.

Meanwhile, the frunk latch apparatus 10 according to one embodiment of the present invention may include a first detection unit 900 for detecting the position of the sector gear unit 500 and a second detection unit 950 for detecting the position of the pawl 420.

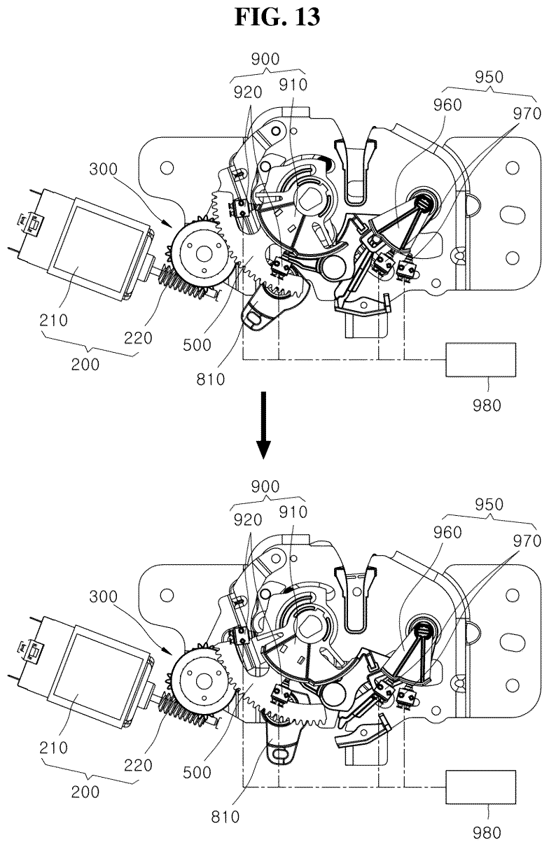

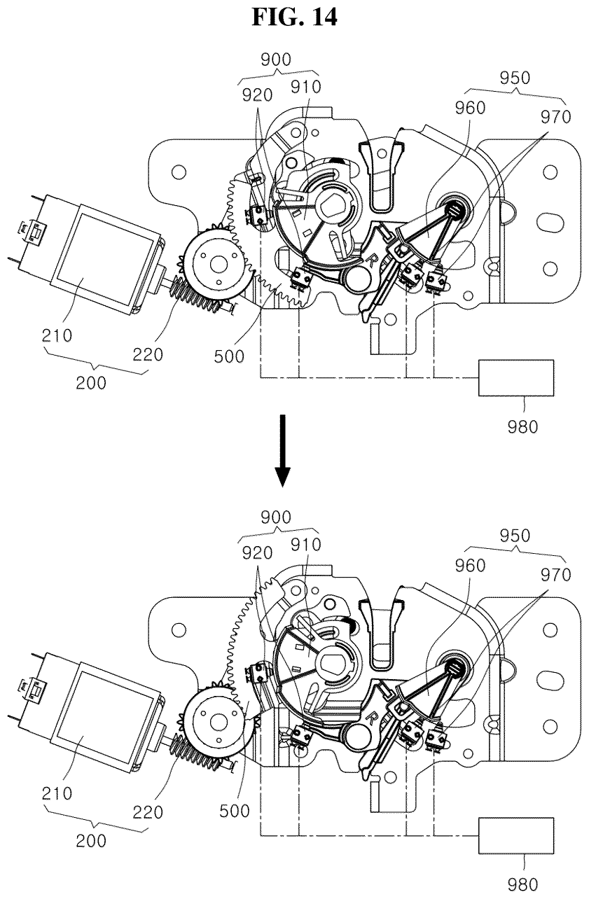

FIG. 13 is a view showing position detection by the power release operation of the frunk latch apparatus according to one embodiment of the present invention, and FIG. 14 is a view showing position detection by the cinching operation of the frunk latch apparatus according to one embodiment of the present invention.

Since positions of the sector gear unit 500 and the pawl 420 may be detected through each of the first and second detection units, the operating state may be checked. That is, the open state, primarily locked state, and completely locked state of the frunk latch apparatus 10 may be checked through the first and second detection units.

Referring to FIGS. 13 and 14, the first detection unit 900 may include a first detection plate 910 that rotates together with the sector gear unit 500 and a pair of first detection switches 920 that are selectively in contact with the first detection plate 910 and disposed to be spaced apart from each other.

A first contact rib is in contact with and selectively presses each of the first detection switches 920 may be formed on the circumferential surface of the first detection plate 910.

The second detection unit 950 may include a second detection plate 960 rotated together with the pawl 420 and a pair of second detection switches 970 that are selectively in contact with the second detection plate 960 and disposed to be spaced apart from each other.

The first detection switch 920 and the second detection switch 970 may be formed of micro switches.

In addition, a control unit 980 may be included to detect the position of the sector gear unit 500 by the first detection unit 900 and the position of the pawl 420 by the second detection unit 950 to display an operating state.

The control unit 980 may be formed of a printed circuit board, detect a malfunction according to each detected position, and display the state of the frunk latch apparatus 10 through a display provided in the vehicle.

Referring to FIG. 13, in the primarily locked state of the latch unit 400 at an initial stage, the pair of first detection switches 920 are in contact with the first detection plate 910 and turned on, the left second detection switch 970 is in contact with the second detection plate 960 and turned on, and the right second detection switch 970 is turned off.

By the counterclockwise rotation of the sector gear unit 500 for the opening operation, the first detection plate 910 is also rotated counterclockwise, the left first detection switch 920 is turned off, and the right first detection switch 920 remains in a turned-on state. In addition, by the rotation of the pawl 420, the second detection plate 960 also rotates counterclockwise so that the second detection switches 970 are both turned on.

The turned-on and off states of the first detection switch 920 and the second detection switch 970 may be detected to check an open state and detect a malfunction.

Referring to FIG. 14, in the primarily locked state of the latch unit 400 at an initial stage, the pair of first detection switches 920 are in contact with the first detection plate 910 and turned on, the left second detection switch 970 is in contact with the second detection plate 960 and turned on, and the right second detection switch 970 is turned off.

In the cinching operation, since the pawl 420 does not move, there is no change in the state of the second detection switch 970, and by the clockwise rotation of the sector gear unit 500 for the cinching operation, the first detection plate 910 may also rotate clockwise, the left first detection switch 920 may be turned on, and the right first detection switch 920 may be secondarily turned on, thereby recognizing the cinching operation.

The turned-on and off states of the first detection switch 920 and the second detection switch 970 may be detected to check a cinching state and detect a malfunction.

According to the present invention having the above configuration, the power release function and the power clinching function may be performed by a single driving unit, thereby enabling the light-weight and miniaturization of the latch apparatus of the door, reducing the manufacturing costs, transmitting high power using the planetary gear, and performing the de-clutch function with a structure that blocks the transmission of the driving force, and thus a compact product can be provided.

As described above, the frunk latch apparatus according to the present invention can perform a power release function and a power clinching function using a single driving unit, thereby enabling the light-weight and miniaturization of a door latch apparatus and reducing a manufacturing cost.

In addition, the present invention can provide a compact product by enabling high power transmission using a planetary gear and performing a de-clutch function with a structure that blocks the transmission of a driving force.

The present invention has been described with reference to embodiments shown in the drawings, but these are merely exemplary, and those skilled in the art will understand that various modifications and equivalent other embodiments are possible therefrom.

Accordingly, the true technical scope of the present invention should be determined by the appended claims.

What is claimed is:

1. A frunk latch apparatus comprising:
a base;
a driving unit provided on the base;
a driven gear unit connected to the driving unit;
a latch unit provided on the base to control opening or closing of a door;
a sector gear unit that is rotated by the driven gear unit and switches the latch unit to a completely locked state; and
a de-clutch unit configured to block power transmission from the driven gear unit to the sector gear unit to stop switching the latch unit to the completely locked state.

2. The frunk latch apparatus of claim 1, wherein the latch unit includes:
a claw provided to be rotatable on the base; and
a pawl that is engaged with the claw and restrains a strike inserted into the claw.

3. The frunk latch apparatus of claim 2, wherein the driven gear unit includes:
a sun gear engaged and rotated with an output power shaft of the driving unit;
a driven gear unit that is engaged and rotated with the sun gear;
a ring gear engaged with the driven gear unit; and
a spur gear coupled to the driven gear unit and engaged with the sector gear unit.

4. The frunk latch apparatus of claim 3, further comprising a cinching operation unit configured to switch the latch unit to the completely locked state in conjunction with rotation of the sector gear unit in the other direction,
wherein the cinching operation unit includes:
a cinching operation member configured to rotate together with the sector gear unit; and
a contact pin formed on the claw to be in contact with the cinching operation member and move the claw to a completely locked position.

5. The frunk latch apparatus of claim 3, wherein the de-clutch unit includes:
a de-clutch lever that is provided to be rotatable on the base and applies a de-clutch operation; and
a power blocking unit configured to block power transmission from the driving unit to the driven gear unit by rotation of the de-clutch lever.

6. The frunk latch apparatus of claim 5, wherein the ring gear is provided to be rotatable on the base, and
the power blocking unit includes:
a restraining shaft that is slidably provided on the base and restrains rotation of the ring gear;
an elastic member configured to provide an elastic force so that the restraining shaft is coupled to the ring gear; and
an operating member configured to release restraint of the ring gear by moving the restraining shaft when the de-clutch lever operates.

7. The frunk latch apparatus of claim 6, wherein a guide groove that guides a sliding movement of the restraining shaft is formed in the base.

8. The frunk latch apparatus of claim 6 wherein the operating member includes a first gear portion formed on the de-clutch lever; and
a second gear portion formed in a longitudinal direction of the restraining shaft to be engaged with the first gear portion.

9. The frunk latch apparatus of claim 2, further comprising an opening operation unit configured to open the latch unit in conjunction with rotation of the sector gear unit in one direction,
wherein the opening operation unit includes:
a release operation member rotated together with the sector gear unit; and
a power drive lever unit that is in contact and rotated with the release operation member and rotates the pawl.

10. The frunk latch apparatus of claim 9, wherein a rolling roller is provided on the release operation member, and
a guide rib in contact with the rolling roller is formed on the power drive lever unit.
